(19) United States
(12) Patent Application Publication
(10) Pub. No.: US 2003/0219701 A1
(43) Pub. Date: Nov. 27, 2003

(54) Simulator for aircraft flight training

(76) Inventor: Bruce E. Zeier, Romoland, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/376,641

(22) Filed: Feb. 26, 2003

Related U.S. Application Data
(63) Continuation-in-part of application No. 09/774,777, filed on Jan. 30, 2001.
Application No. 09/774,777 is a continuation-in-part of application No. 09/570,328, filed on May 12, 2000, now abandoned.

(51) Int. Cl. G09B 9/08; G09B 19/16

(52) U.S. Cl. 434/33

(57) ABSTRACT

A flight simulating apparatus is capable of directing combinations of elevation, yaw, roll, pitch and three-space accelerations to a cockpit. Continuous rotation is provided by a rotational drive and elevation, roll and pitch are provided by linear positioning devices engaged with the rotational drive and extending upwardly from it. An x-y table and the elevation linear positioning device provide accelerating forces.

### RELATED APPLICATIONS

This is a continuation-in-part application of a prior filed and currently pending application having Ser. No. 09/774,777 and file date of Jan. 30, 2001 now pending, which is a continuation-in-part of Ser. No. 09/570,328 having file date of May 12, 2000 which has been abandoned.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to flight simulators and similar apparatus, and more particularly to a simulator that simultaneously provides full continuous rotation of a cockpit as well as fully independent vertical, horizontal, pitch, and roll motions.

2. Description of Related Art

The following art defines the present state of this field as defined by two literature searches conducted in examination of the sited parent applications to this continuation-in-part application.

Allison et al, U.S. Pat. No. 4,601,663 teaches a helicopter simulator enabled for vertical, yaw, pitch and roll motions. Clark, U.S. Pat. No. 2,805,061 teaches an amusement device with vertical, yaw and pitch but without roll motion. Stensager, U.S. Pat. No. 3,137,500 also teaches an amusement device using a linear positioning actuator for vertical motion, and actuation for yaw, pitch and roll motions. Helper, U.S. Pat. No. 1,934,464 teaches a simulator capable of yaw, pitch and roll motions but without vertical motion. Meghnot et al U.S. Pat. No. 6,283,757 teaches an operator platform with two orthogonal axis of tilt to simulate pitch and roll motions, but which does not teach enablement for yaw or vertical motions. Alet et al U.S. Pat. No. 6,077,078 teaches motion actuation in an x-y plane, but does not teach an enablement for a flight simulator having additionally, yaw, roll, pitch and vertical motions. No combination of the above-sited references teaches how to enable vertical, yaw, pitch and roll positioning of a cockpit simultaneously with independent accelerations about the three orthogonal axes of three-space. However, the present invention fulfills these needs and provides further related advantages as described in the following summary.

### SUMMARY OF THE INVENTION

The present invention teaches certain benefits in construction and use, which give rise to the objectives described below.

In order to simulate the full motion and inertial forces experienced in flight, a stationary trainer must execute the orientation motions of yaw, roll and pitch that an aircraft will experience, and also it must provide vertical and horizontal (x, y, and z) accelerations so as to impart to the student, the inertial forces experienced during climb, dive and the various lateral motions of the aircraft. The prior art does not teach how this objective may be accomplished and therefore, prior art simulators lack inertial and orientation realism. Clearly, an aircraft pilot may experience negative inertial forces of acceleration (negative G-forces) along the longitudinal axis of his aircraft, with simultaneous vertical axis acceleration (positive G-forces) while at the same time the aircraft is rolling to the left, yawing right and pitching nose upwardly, for instance. The prior art does not teach how this may be simulated. It should be noted that to achieve true flight realism, the positioning of the cockpit, i.e., enablement of the cockpit to move in yaw, pitch and roll, from one orientation to another must be separated from the enablement of acceleration forces in three-space on the cockpit. This is because, in actual flight, forces acting on an aircraft include independent sources including thrust and drag vectors, lift and weight, as well as inertial forces resulting from these, and also, completely independent aerodynamic forces from slipstream, weather and a variety of other sources. Therefore, the positional manipulation of a simulator cockpit is not enough to achieve realism. Wholly independent attitudinal and acceleration manipulations are necessary as taught herein.

Without providing independent positioning motions and accelerations to a cockpit it is impossible for the student to experience the full realism of actual flight. The present flight simulating apparatus is capable of directing combinations of elevation change, yaw, roll, pitch and three-space accelerations to a cockpit. Continuous rotation is provided by a rotational drive and elevation, roll and pitch are provided by linear positioning devices engaged with the rotational drive and extending upwardly from it. An x-y table and the elevation linear positioning device provide the accelerating forces.

A primary objective of the present invention is to provide a flight simulator apparatus having advantages not taught by the prior art.

A further objective is to provide a flight training simulator-providing: yaw, roll, and pitch motions of a trainer cockpit, as well as the inertial forces in x-y and i-directions for realistic simulation of aircraft maneuvers in three-dimensional air space.

An important objective of the present invention is to provide true continuous rotation of the cockpit.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1A is a perspective view of a first preferred embodiment of the present invention;

FIG. 1B is a perspective view of a second preferred embodiment of the present invention;

FIG. 2A is an exploded perspective view of the first embodiment showing the method of mounting a platform for an x-y table below a cockpit of the invention;

FIG. 2B is an exploded perspective view of the first embodiment showing placement of the x-y table on the platform;

FIGS. 3-14 are elevational views thereof with an x-y direction acceleration table mounted directly under the cockpit and illustrating the cockpit in: stationary horizontal attitude; motion along an x-direction; motion along a z-direction; negative pitch motion; positive pitch motion; start of left yaw motion; continuing left yaw motion; right yaw motion; motion in y-direction; left roll motion; left roll motion coupled with negative z-direction acceleration; and positive pitch coupled with side-to-side yaw, respectively;

FIGS. 15-23 are elevational views thereof with an x-y direction acceleration table mounted directly under a rotation device of the invention and illustrating the cockpit in: stationary horizontal attitude; motion along an x-direction; motion along a z-direction; negative pitch motion; right yaw motion; motion in y-direction; left roll motion; left roll motion coupled with negative z-direction acceleration; and positive pitch coupled with side-to-side yaw and motion in y-direction, respectively; and

FIG. 24 is a block diagram of the actuation and control system thereof.

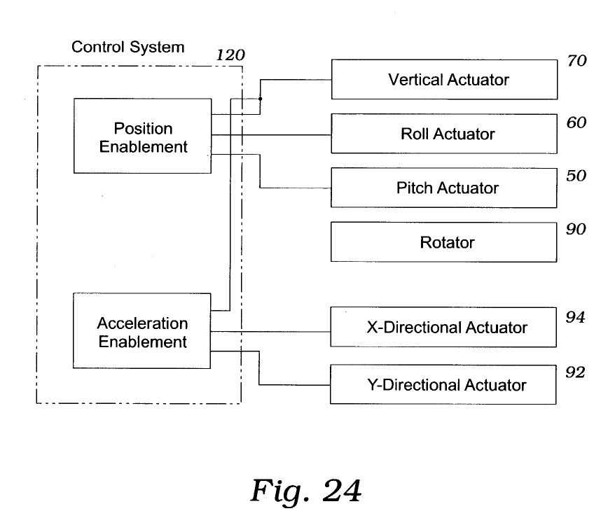

### DETAILED DESCRIPTION OF THE INVENTION

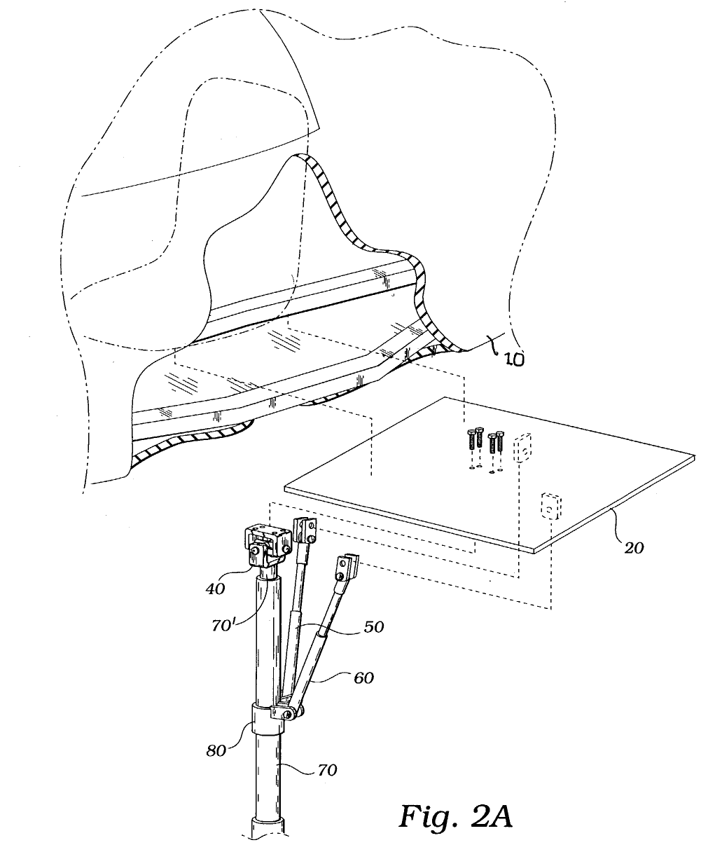

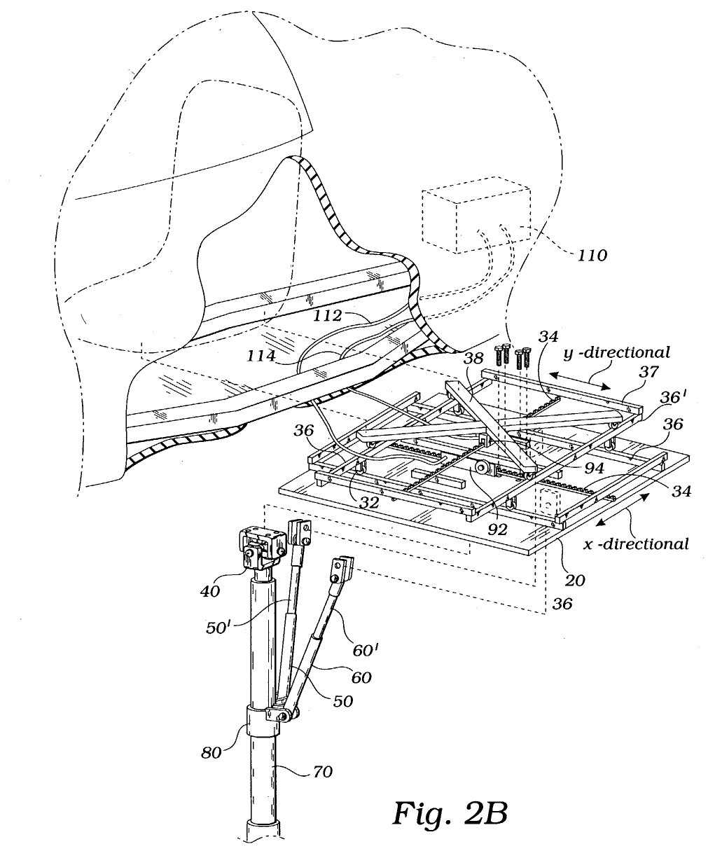

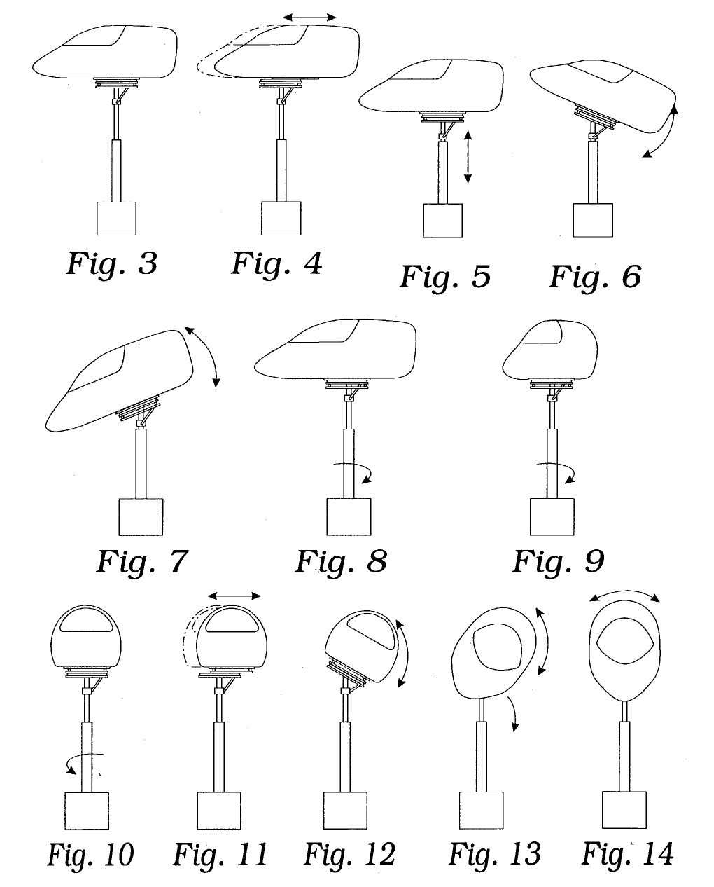

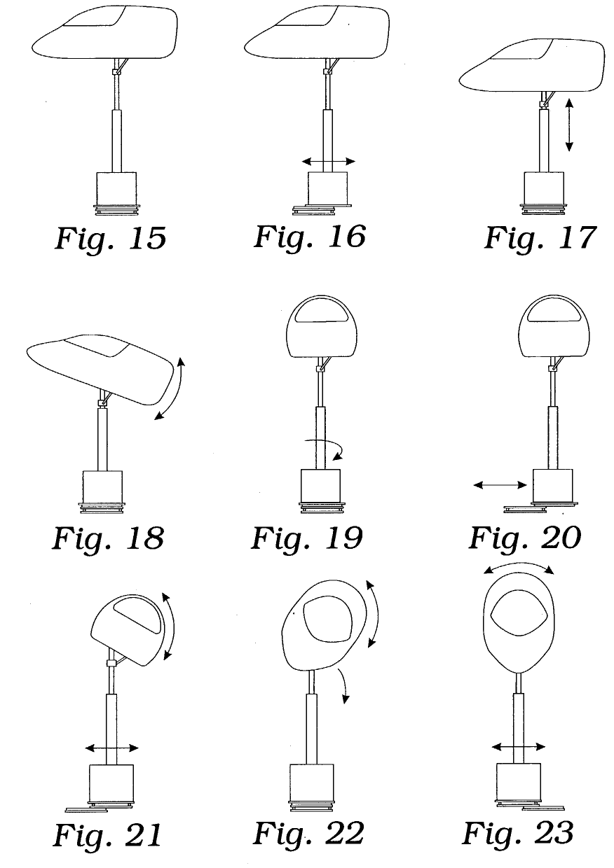

The above drawing figures illustrate the invention, a flight simulator apparatus comprised of a cockpit 10 which is movable in yaw, roll and pitch, and able to be moved in short acceleration motions as well in combinations of the x (100′), y (100″) and z (100) directions, where the x-direction is along the longitudinal axis of the cockpit, the y-direction is along the lateral axis of the cockpit, and the z-direction is along the vertical axis of the cockpit. As shown in FIG. 2A or 2B, the cockpit 10 rests, either directly on a platform 20, or on an x-y motion table 30 which itself is mounted on the platform 20. The platform 20, in turn, is mounted on a gimble 40 and linear actuator means 50, 60 and 70 as shown in FIGS. 2A and 2B. The gimble 40, shown in FIGS. 2A and 2B enables the cockpit 10 to move through complex motions as shown in FIGS. 3-23.

A means for continuous yaw rotation 90, preferably a hydraulic or pneumatic or electric motor, provides rotation in either rotational direction about the vertical axis 100. A first linear actuator 70 provides vertical positioning to cockpit 10 as shown in FIGS. 5, 13, 17 and 22. The actuators 50, 60 and 70 are preferably hydraulic cylinders with pistons 50′, 60′, 70′ able to move with telescoping motion in either direction, i.e., extension, retraction, as is well known. Second and third actuators 50, 60 are fixedly mounted by collar 80 to first actuator 70 and are able to pivot about pivot joints 82. Actuators 50, 60 are positioned at right angles to each other, with actuator 50 aligned in the x-direction and actuator 60 aligned in the y-direction; the actuator 50 is thereby enabled for causing pitching motions to the cockpit 10 as shown in FIGS. 6, 7, 13, 14, 18, 21 and 22, and the actuator 60 is thereby enabled for causing rolling motions to the cockpit 10 as shown in FIGS. 12, 13, 21 and 22.

Hydraulic accumulator 110 produces hydraulic pressure, which is transferred through lines 112 and 114 to actuators 50, 60, 70 as well as x-y-direction actuators 92 and 94, the later producing acceleration of the cockpit 10 in the y-direction and the x-direction respectively as shown in FIG. 2B. Pressure lines for actuators 50, 60 and 70 are not shown in the figures, but are used in the same manner as for actuators 92 and 94.

Means for continuous yaw rotation 90 turns actuator 70, which is joined to a rotating member of rotating means 90. Therefore, the cockpit 10 is able to rotate in either direction continuously.

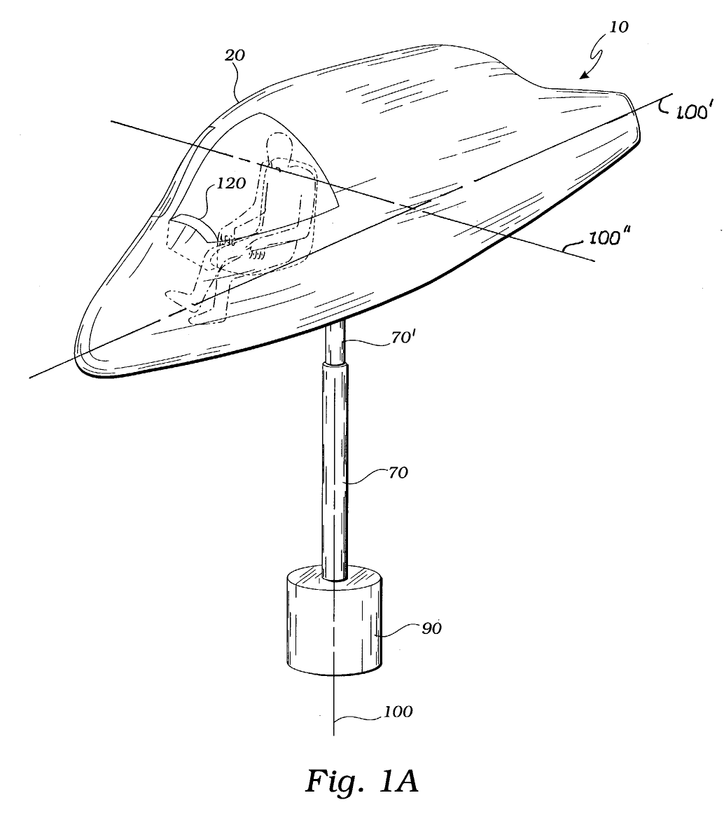

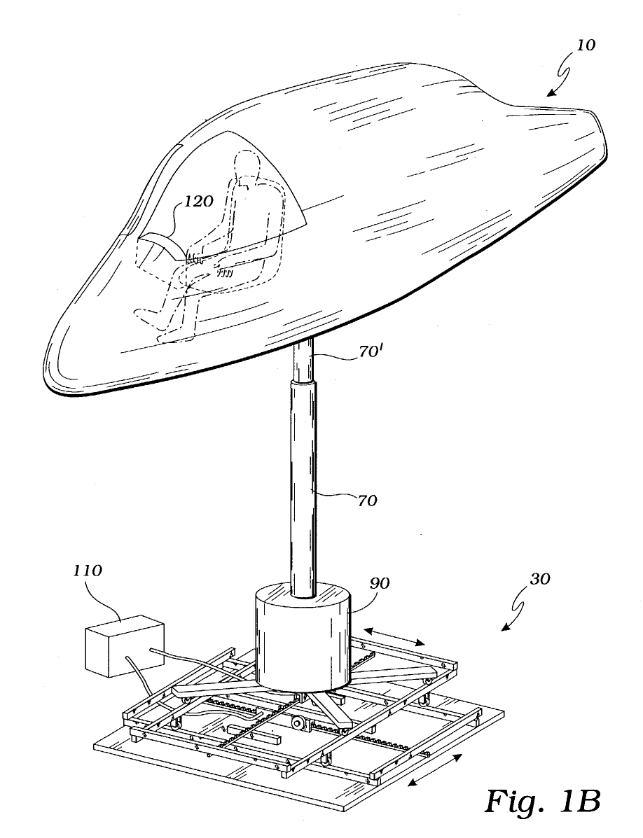

In a further enablement of the present invention, shown in FIGS. 1B the x-y direction table 30 is mounted under rotating means 90 and therefore is able to accelerate the rotator 90, actuator 70, and cockpit 10 in the x-direction, y-direction and combinations of these two directions. In this embodiment, the cockpit 10 is mounted directly onto the platform 20. Alternately, the cockpit 10 may be mounted directly onto the gimble 40. The several mounting and fastening arrangements would be easily completed by one of skill in the art with common fasteners and well known techniques.

The x-y direction table 30 incorporates platform 20, V-groove wheels 32, actuators 92 and 94, which may be hydraulic drive motors, stationary linear gears 34, and parallel V-tracks 36. Platform 20 supports parallel tracks 36, which are positioned in the y-direction as shown by the arrow in FIG. 2B. Frame 37 is supported on tracks 36 by V-grooved wheels 32 which engage the y-direction tracks 36 for movement in the y-direction thereon. Frame 38 is supported on tracks 36′ by V-grooved wheels 32 which engage these x-direction tracks 36′ for movement in the x-direction thereon.

Drive forces are controlled by a flight control system through hydraulic, pneumatic or electrical actuating valves, as is well known, and they in turn provide the operational signals to drive the actuators and the rotating means 90. The simultaneous actuation of these elements results in the omnidirectional motions necessary for full flight simulation as discussed above.

In operation, the student pilot actuates the various devices, including the rotating means 90 and the several actuators to produce any combination of inertial forces at cockpit 10, including any combination of elevational change while yawing, rolling and/or pitching, and lateral or longitudinal acceleration forces. The invention is enabled to simulate helicopter or airplane flight attributes through computer control of the described control mechanisms. Such computer control of actuation devices for simulators is very well developed in the art and described in the background above.

While the invention has been described with reference to at least two preferred embodiments, it is to be clearly understood by those skilled in the art that the invention is not limited thereto. Rather, the scope of the invention is to be interpreted only in conjunction with the appended claims.

What is claimed is:

1. A flight simulating apparatus for accelerating in x, y, and z mutually orthogonal directions and in executing pitch, roll and yaw motions, the apparatus comprising: elements secured in vertical sequence including a cockpit, a means for simultaneous accelerations in the x-direction and the y-direction; a platform, a gimble, a first, second and third means for linear actuation, and a means for continuous yaw rotation about the z-direction; the first means for linear actuation providing positioning of, and acceleration to, the cockpit in the z-direction; the second and the third linear actuation means pivotally engaged between the first linear actuation means and the cockpit and enabling positioning of the cockpit in roll and in-pitch motions.

2. The apparatus of claim 1 wherein the means for continuous yaw rotation and the first, second and third linear positioning means are pressure-actuated devices.

3. A flight simulating apparatus for accelerating in x, y, and z mutually orthogonal directions and in executing pitch, roll and yaw motions, the apparatus comprising: elements secured in vertical sequence including a cockpit, a platform, a gimble, a first, second and third means for linear actuation, a means for continuous yaw rotation about the z-direction, and a means for simultaneous accelerations in the x-direction and the y-direction; the first means for linear actuation providing positioning of, and acceleration to, the cockpit in the z-direction; the second and the third linear actuation means pivotally engaged between the first linear actuation means and the cockpit and enabling positioning of the cockpit in roll and in pitch motions.

4. The apparatus of claim 3 wherein the means for continuous yaw rotation and the first, second and third linear positioning means are pressure-actuated devices.
